(19) United States
(12) Patent Application Publication
(10) Pub. No.: US 2021/0141697 A1
(43) Pub. Date: May 13, 2021

(54) Mission-Critical AI Processor with Multi-Layer Fault Tolerance Support

(71) Applicant: DINOPLUSAI HOLDINGS LIMITED, Fremont, CA (US)

(72) Inventors: Chung Kuang CHIN, Saratoga, CA (US); Yujie HU, Fremont, CA (US); Tong WU, Fremont, CA (US); Clifford GOLD, Fremont, CA (US); Yick Kei WONG, Union City, CA (US); Xiaosong WANG, Fremont, CA (US); Steven SERTILLANGE, San Leandro, CA (US); Zongwei ZHU, Sunnyvale, CA (US)

(21) Appl. No.: 16/976,063

(22) PCT Filed: Feb. 25, 2019
(86) PCT No.: PCT/US19/19451

§ 371 Date: Aug. 26, 2020

Related U.S. Application Data
(60) Provisional application No. 62/639,451, filed on Mar. 6, 2018.
(60) Provisional application No. 62/640,800, filed on Mar. 9, 2018.
(60) Provisional application No. 62/640,804, filed on Mar. 9, 2018.
(60) Provisional application No. 62/654,761, filed on Apr. 9, 2018.

(51) Int. Cl. G06F 11/14; G06N 3/04; G06F 11/10; G06F 13/42

(52) U.S. Cl. CPC G06F 11/1469; G06N 3/04; G06F 2213/0026; G06F 13/4282; G06F 2201/82; G06F 11/1076

(57) ABSTRACT

Embodiments described herein provide a mission-critical artificial intelligence (AI) processor (MAIP), which includes multiple types of HEs (hardware elements) comprising one or more HEs configured to perform operations associated with multi-layer NN (neural network) processing, at least one spare HE, a data buffer to store correctly computed data in a previous layer of multi-layer NN processing computed, and fault tolerance (FT) control logic. The FT control logic is configured to: determine a fault in a current layer NN processing associated with the HE; cause the correctly computed data in the previous layer of multi-layer NN processing to be copied or moved to said at least one spare HE; and cause said at least one spare HE to perform the current layer NN processing using said at least one spare HE and the correctly computed data in the previous layer of multi-layer NN processing.

### CROSS REFERENCES

This application claims the benefit of U.S. Provisional Application No. 62/639,451, filed 6 Mar. 2018, U.S. Provisional Application No. 62/640,800, filed 9 Mar. 2018, U.S. Provisional Application No. 62/640,804, filed 9 Mar. 2018 and U.S. Provisional Application No. 62/654,761, filed Apr. 9, 2018. The U.S. Provisional Applications are incorporated by reference herein.

### BACKGROUND

### Field

This disclosure is generally related to the field of artificial intelligence (AI). More specifically, this disclosure is related to a system and method for facilitating a processor capable of processing mission-critical AI applications on a real-time system.

### Related Art

The exponential growth of AI applications has made them a popular medium for mission-critical systems, such as a real-time self-driving vehicle or a critical financial transaction. Such applications have brought with them an increasing demand for efficient AI processing. As a result, equipment vendors race to build larger and faster processors with versatile capabilities, such as graphics processing, to efficiently process AI-related applications. However, a graphics processor may not accommodate efficient processing of mission-critical data. The graphics processor can be limited by processing constraints and design complexity, to name a few factors.

As more mission-critical features (e.g., features dependent on fast and accurate decision-making) are being implemented in a variety of systems (e.g., automatic braking of a vehicle), an AI system is becoming progressively more important as a value proposition for system designers. Typically, the AI system uses data, AI models, and computational capabilities. Extensive use of input devices (e.g., sensors, cameras, etc.) has led to generation of large quantities of data, which is often referred to as “big data,” that an AI system uses. AI systems can use large and complex models that can infer decisions from big data. However, the efficiency of execution of large models on big data depends on the computational capabilities, which may become a bottleneck for the AI system. To address this issue, the AI system can use processors capable of handling AI models.

Therefore, it is often desirable to equip processors with AI capabilities. Typically, tensors are often used to represent data associated with AI systems, store internal representations of AI operations, and analyze and train AI models. To efficiently process tensors, some vendors have used tensor processing units (TPUs), which are processing units designed for handling tensor-based computations. TPUs can be used for running AI models and may provide high throughput for low-precision mathematical operations.

While TPUs bring many desirable features to an AI system, some issues remain unsolved for handling mission-critical scenarios.

### A BRIEF SUMMARY OF THE INVENTION

Embodiments described herein provide a mission-critical artificial intelligence (AI) processor (MAIP), which includes multiple types of HEs (hardware elements), at least one spare first-type HE, a data buffer, and fault tolerance (FT) control logic. The multiple types of HEs comprise a first-type HE (hardware element) configured to perform operations associated with multi-layer NN (neural network) processing. The data buffer is configured to store correctly computed data in a previous layer of multi-layer NN processing computed using said one or more first-type HEs. The fault tolerance (FT) control logic is configured to: determine a fault in a current layer NN processing associated with said one or more first-type HEs; cause the correctly computed data in the previous layer of multi-layer NN processing to be copied or moved to said at least one spare first-type HE; and cause said at least one spare first-type HE to perform the current layer NN processing using said at least one spare first-type HE and the correctly computed data in the previous layer of multi-layer NN processing.

In one embodiment of the mission-critical AI processor, said one or more first-type HEs comprises one or more matrix multiplier units (MXUs), weight buffers (WBs) or processing elements (PEs). In another embodiment of the mission-critical AI processor, said one or more first-type HEs comprises one or more scalar computing units (SCUs) or scalar elements (SEs). In yet another embodiment of the mission-critical AI processor, said one or more first-type HEs comprises one or more registers, DMA (direct memory access) controllers, on-chip memory banks, command sequencers (CSQs) or a combination thereof.

In one embodiment of the mission-critical AI processor, when said one or more first-type HEs corresponds to a storage, information redundancy is used to detect storage error and the fault corresponds to an un-correctable storage error. In this case, the information redundancy may correspond to error-correction coding (ECC).

In one embodiment of the mission-critical AI processor, at least three first-type HEs (hardware elements) are used to execute same operations and the fault corresponds to a condition that no majority result can be determined among said at least three first-type HEs.

A method for mission-critical AI (Artificial Intelligence) processing is also disclosed. According to this method, the correctly computed data, calculated using a mission-critical AI processor, in a previous layer of multi-layer NN (Neural Network) processing are stored. The mission-critical operations are performed with at least one type of redundancy for a current layer of multi-layer NN processing using the mission-critical AI processor. Whether a fault occurs is determined based on results of the mission-critical operations for the current layer of multi-layer NN processing. In response to the fault, the mission-critical operations are re-performed for the current layer of multi-layer NN processing using the mission-critical AI processor and the correctly computed data in the previous layer of multi-layer NN processing. Therefore, the method according to the present invention is capable of quickly re-performing the operations for a current layer from a corrected computed last layer when a fault is determined for the current layer.

Said at least one type of redundancy may comprise hardware redundancy, information redundancy, time redundancy or a combination thereof.

In the case of hardware redundancy, the mission-critical AI processor may comprise multiple hardware elements (HEs) for at least one type of hardware element (HE), where two or more HEs for said at least one type of HE are used to perform same mission-critical operations for the current layer of multi-layer NN processing. If results of the same mission-critical operations for the current layer of multi-layer NN processing do not match, but a majority result of the same mission-critical operations for the current layer of multi-layer NN processing exists, then no fault is declared and the majority result of the same mission-critical operations for the current layer of multi-layer NN processing is used as the correctly computed data for the current layer of multi-layer NN processing. If results of the same mission-critical operations for the current layer of multi-layer NN processing do not match and no majority result of the same mission-critical operations for the current layer of multi-layer NN processing exists, then the fault is determined.

In the case of information redundancy, the mission-critical AI processor uses at least one type of data with redundant information to detect data error in said at least one type of data, where said at least one type of data is associated with the mission-critical operations for the current layer of multi-layer NN processing. When the data error in said at least one type of data is un-recoverable and the data error is due to data transfer, said at least one type of data is re-transferred. When the data error in said at least one type of data is un-recoverable and the data error is not due to data transfer, the fault is determined.

The mission-critical AI processor may use error-correcting-coding (ECC) to provide the redundant information for said at least one type of data. Said at least one type of data may be associated with data storage using registers, on-chip memory, weight buffer (WB), unified buffer (UB) or a combination thereof.

In the case of time redundancy, the mission-critical AI processor may perform same mission-critical operations at least twice for the current layer of multi-layer NN processing. If results of the same mission-critical operations for the current layer of multi-layer NN processing do not match, but a majority result of the same mission-critical operations for the current layer of multi-layer NN processing exists, no fault is declared and the majority result of the same mission-critical operations for the current layer of multi-layer NN processing is used as the correctly computed data for the current layer of multi-layer NN processing. If results of the same mission-critical operations for the current layer of multi-layer NN processing do not match and no majority result of the same mission-critical operations for the current layer of multi-layer NN processing exists, the fault is determined.

A mission-critical AI (Artificial Intelligence) system is also disclosed, where the system comprises a system processor, a system memory device, a communication interface and the mission-critical AI processor as disclosed above. The communication interface may correspond to a peripheral component interconnect express (PCIe) interface or a network interface card (NIC).

### BRIEF DESCRIPTION OF THE FIGURES

FIG. 1A illustrates an exemplary mission-critical system equipped with mission-critical AI (artificial intelligence) processors (MAIPs) supporting fault tolerance, in accordance with an embodiment of the present application.

FIG. 1B illustrates an exemplary system stack of a mission-critical AI (artificial intelligence) system, in accordance with an embodiment of the present application.

FIG. 1C illustrates an exemplary fault tolerance strategy of an MAIP supporting fault tolerance based on hardware redundancy, time redundancy and/or information redundancy, in accordance with an embodiment of the present application.

FIG. 2A illustrates an exemplary chip architecture of a tensor computing unit (TCU) in an MAIP supporting fault tolerance, in accordance with an embodiment of the present application.

FIG. 2B illustrates an exemplary chip architecture of a TCU cluster in an MAIP supporting fault tolerance, in accordance with an embodiment of the present application.

FIG. 3 illustrates an exemplary architecture of an MAIP supporting fault tolerance, in accordance with an embodiment of the present application.

FIG. 4A illustrates exemplary information redundancy and hardware redundancy for facilitating fault tolerance in an MAIP, in accordance with an embodiment of the present application.

FIG. 4B illustrates exemplary self-testing and time redundancy for facilitating fault tolerance in an MAIP, in accordance with an embodiment of the present application.

FIG. 5A presents a flowchart illustrating a method of an MAIP testing for and recovering from a permanent failure based on an MAIP system comprising a hardware element and a space hardware element, in accordance with an embodiment of the present application.

FIG. 5B presents a flowchart illustrating a method of an MAIP facilitating fault recovery using information redundancy, in accordance with an embodiment of the present application.

FIG. 5C presents a flowchart illustrating a method of an MAIP facilitating fault recovery using hardware redundancy, in accordance with an embodiment of the present application.

FIG. 5D presents a flowchart illustrating a method of an MAIP facilitating fault recovery using time redundancy, in accordance with an embodiment of the present application.

FIG. 6 presents a flowchart illustrating a method of an MAIP rolling back to a correct computation layer using spare hardware element, in accordance with an embodiment of the present application.

FIG. 7 illustrates an exemplary computer system supporting a mission-critical system, in accordance with an embodiment of the present application.

FIG. 8 illustrates an exemplary apparatus that supports a mission-critical system, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### OVERVIEW

The embodiments described herein solve the problem of facilitating fault tolerance in a mission-critical AI processor (MAIP) by incorporating hardware, time, and information redundancy within the chip of the MAIP. Hardware redundancy provides a spare hardware element to an individual or a group of hardware elements in an MAIP. Time redundancy ensures that a calculation is performed multiple times (e.g., same hardware element calculating multiple times or multiple hardware elements in parallel). Information redundancy incorporates additional bits, such as error-correction coding (ECC), that can detect errors in a set of bits. To protect individual hardware elements within the MAIP, such as registers, accumulator, and matrix multiplier unit (MXU), the MAIP incorporates spare hardware, ECC, self-checking, and repeated computations using multiple hardware elements.

Many mission-critical systems rely on AI applications to make instantaneous and accurate decisions based on the surrounding real-time environment. An AI application can use one or more AI models (e.g., a neural-network-based model) to produce a decision. Usually, the system uses a number of input devices, such as sensors (e.g., sonar and laser), cameras, and radar, to obtain real-time data. Since the system can use a large number of such input devices, they may generate a large quantity of data based on which the AI applications make decisions. To process such a large quantity of data, the system can use large and complex AI models that can generate the decisions. For example, the safety features of a car, such as automatic braking and lane departure control, may use an AI model that processes real-time data from on-board input devices of the car.

With existing technologies, AI applications may run on graphics processing units (GPUs) or tensor processing units (TPUs). Typically, a GPU may have a higher processing capability between these two options (e.g., indicated by a high floating point operations per second (FLOPS) count). However, since a GPU is designed for vector and matrix manipulations, the GPU may not be suitable for all forms of tensor. In particular, since a mission-critical system may use data from a variety of input devices, the input data can be represented based on tensors with varying dimensions. As a result, the processing capabilities of the GPU may not be properly used for all AI applications.

On the other hand, a TPU may have the capability to process tensor-based computations more efficiently. However, a TPU may have a lower processing capability. Furthermore, some TPUs may only be efficiently used for applying AI models but not for training the models. Using such a TPU on a mission-critical system may limit the capability of the system to learn from a new and dynamic situation. Therefore, existing GPUs and TPUs may not be able to process large and time-sensitive data of a mission-critical system with high throughput and low latency. In addition, existing GPUs and TPUs may not be able to facilitate other important requirements of a mission-critical system, such as high availability for failure scenarios.

Moreover, for some AI models, such as neural-network-based models, the system provides a set of inputs, which is referred to as an input layer, to obtain a set of outputs, which is referred to as an output layer. The results from intermediate stages, which are referred to as intermediate layers or hidden layers, are essential to reach the output layer. However, if a hardware component of a processor suffers a failure, the computations associated with the intermediate layers are not transferrable to other hardware modules. As a result, the computations associated with the AI model can be lost.

To solve these problems, embodiments described herein provide an MAIP, which can be an AI processor chip, that can process tensors with varying dimensions with high throughput and low latency. Furthermore, an MAIP can also process training data with high efficiency. As a result, the mission-critical system can be efficiently trained for new and diverse real-time scenarios. In addition, since any failure associated with the system can cause critical problems, the MAIP can detect errors (e.g., error in storage, such as memory error, and error in computations, such as gate error) and efficiently address the detected error. This feature allows the MAIP to facilitate high availability in critical failure scenarios.

The MAIP can also operate in a reduced computation mode in a power failure. If the system suffers a power failure, the MAIP can detect the failure and switch to a backup power source (e.g., a battery). The MAIP then can only use the resources (e.g., the tensor computing units or TCUs) for processing the critical operations, thereby using low power for computations.

Moreover, the MAIP facilitates hardware-assisted virtualization to AI applications. For example, the resources of the MAIP can be virtualized in such a way that the resources are efficiently divided among multiple AI applications. Each AI application may perceive that the application is using all resources of the MAIP. In addition, the MAIP is equipped with an on-board security chip (e.g., a hardware-based encryption chip) that can encrypt output data of an instruction (e.g., data resulting from a computation associated with the instruction). This prevents any rogue application from accessing on-chip data (e.g., from the registers of the MAIP).

Furthermore, a record and replay feature of the MAIP allows the system (or a user of the system) to analyze stage contexts associated with the intermediate stages of an AI model and determine the cause of any failure associated with the system and/or the model. Upon detecting the cause, the system (or the user of the system) can reconfigure the system to avoid future failures. The record and replay feature can be implemented for the MAIP using a dedicated processor/hardware instruction (or instruction set) that allows the recording of the contexts of the AI model, such as intermediate stage contexts (e.g., feature maps and data generated from the intermediate stages) of the AI model. This instruction can be appended to an instruction block associated with an intermediate stage. The instruction can be preloaded (e.g., inserted prior to the execution) or inserted dynamically during runtime. The replay can be executed on a software simulator or a separate hardware system (e.g., with another MAIP).

The term “processor” refers to any hardware unit, such as an electronic circuit, that can perform an operation, such as a mathematical operation on some data or a control operation for controlling an action of a system. The processor can be an application-specific integrated circuit (ASIC) chip.

The term “application” refers to an application running on a user device, which can issue an instruction for a processor. An AI application can be an application that can issue an instruction associated with an AI model (e.g., a neural network) for the processor.

### Exemplary System

FIG. 1A illustrates an exemplary mission-critical system equipped with MAIPs supporting storage and replay, in accordance with an embodiment of the present application. In this example, a mission-critical system 110 operates in a real-time environment 100, which can be an environment where system 110 may make real-time decisions. For example, environment 100 can be an environment commonly used by a person, such as a road system with traffic, and system 110 can operate in a car. Environment 100 can also be a virtual environment, such as a financial system, and system 110 can determine financial transactions. Furthermore, environment 100 can also be an extreme environment, such as a disaster zone, and system 110 can operate on a rescue device.

Mission-critical system 110 relies on AI applications 114 to make instantaneous and accurate decisions based on surrounding environment 100. AI applications 114 can include one or more AI models 113 and 115. System 110 can be equipped with one or more input devices 112, such as sensors, cameras, and radar, to obtain real-time input data 102. System 110 can apply AI model 113 to input data 102 to produce a decision 104. For example, if AI model 113 (or 115) is a neural-network-based model, input data 102 can represent an input layer for the model and decision 104 can be the corresponding output layer.

Since modern mission-critical systems can use a large number of various input devices, input devices 112 of system 110 can be diverse and large in number. Hence, input devices 112 may generate a large quantity of real-time input data 102. As a result, to produce decision 104, AI applications 114 need to be capable of processing a large quantity of data. Hence, AI models 113 and 115 can be large and complex AI models that can generate decision 104 in real time. For example, if system 110 facilitates the safety features of a car, such as automatic braking and lane departure control, continuous real-time monitoring of the road conditions using input devices 112 can generate a large quantity of input data 102. AI applications 114 can then apply AI models 113 and/or 115 to determine decision 104, which indicates whether the car should brake or has departed from its lane.

System 110 can include a set of system hardware 116, such as a processor (e.g., a general purpose or a system processor), a memory device (e.g., a dual in-line memory module or DIMM), and a storage device (e.g., a hard disk drive or a solid-state drive (SSD)). The system software, such as the operating system and device firmware of system 110, can run on system hardware 116. System 110 can also include a set of AI hardware 118. With existing technologies, AI hardware 118 can include a set of GPUs or TPUs. AI applications 114 can run on the GPUs or TPUs of AI hardware 118.

However, a GPU may not be suitable for all forms of tensor. In particular, since system 110 may use data from a variety of input devices 112, input data 102 can be represented based on tensors with varying dimensions. As a result, the processing capabilities of a GPU may not be properly used by AI applications 114. On the other hand, a TPU may have the capability to process tensor-based computations more efficiently. However, a TPU may have a lower processing capability, and may only be efficiently used for applying AI models but not for training the models. Using such a TPU on system 110 may limit the capability of system 110 to learn from a new and dynamic situation.

Therefore, existing GPUs and TPUs may not be able to efficiently process large and time-sensitive input data 102 for system 110. In addition, existing GPUs and TPUs may not be able to facilitate other important requirements of system 110, such as high availability and low-power computation for failure scenarios. Moreover, a processor may not include hardware support for facilitating error/fault recovery. As a result, if the AI model fails to produce a correct result or system 110 suffers a failure, system 110 may not be capable of recovering the failure in real time.

To solve these problems, AI hardware 118 of system 110 can be equipped with a number of MAIPs 122, 124, 126, and 128 that can efficiently process tensors with varying dimensions. These MAIPs can also process training data with high efficiency. As a result, system 110 can be efficiently trained for new and diverse real-time scenarios. In addition, these MAIPs are capable of providing on-chip fault tolerance. AI hardware 118, equipped with MAIPs 122, 124, 126, and 128, thus can efficiently run AI applications 114, which can apply AI models 113 and/or 115 to input data 102 to generate decision 104 with low latency. For example, with existing technologies, if a datacenter uses 100 GPUs, the datacenter may use 10 GPUs for training and 90 GPUs for inference, because 90% of GPUs are typically used for inference. However, similar levels of computational performance can be achieved using 10 MAIPs for training and 15 MAIPs for inference. This can lead to a significant cost savings for the datacenter. Therefore, in addition to mission-critical systems, an MAIP can facilitate efficient computations of AI models for datacenters as well.

An MAIP, such as MAIP 128, can include a TCU cluster 148 formed by a number of TCUs. Each TCU, such as TCU 146, can include a number of dataflow processor unit (DPU) clusters. Each DPU cluster, such as DPU cluster 144, can include a number of DPUs. Each DPU, such as DPU 142, can include a scalar computing unit (SCU) 140 and a vector computing unit (VCU) 141. SCU 140 can include a plurality of traditional CPU cores for processing scalar data. VCU 141 can include a plurality of tensor cores used for processing tensor data (e.g., data represented by vectors, matrices, and/or tensors). In the same way, MAIPs 122, 124, and 126 can include one or more TCU clusters, each formed based on DPUs comprising SCUs and VCUs.

In some embodiments, MAIP 128 can also operate in a reduced computation mode in a power failure. If system 110 suffers a power failure, MAIP 128 can detect the failure and switch to a backup power source 138. This power source can be part of AI hardware 118 or any other part of system 110. MAIP 128 then can use the resources (e.g., the TCUs) for processing the critical operations of system 110. MAIP 128 can turn off some TCUs, thereby using low power for computation. System 110 can also turn off one or more of the MAIPs of AI hardware 118 to save power. If the power comes back, system 110 can resume regular computation mode.

Moreover, MAIP 128 can facilitate hardware-assisted virtualization to AI applications. For example, AI hardware 118 can include a virtualization module 136, which can be incorporated in a respective MAIP or a separate module. Virtualization module 136 can present the resources of MAIPs 122, 124, 126, and 128 as virtualized resources 130 in such a way that the resources are efficiently divided among multiple AI applications. Each AI application may perceive that the application is using all resources of an MAIP and/or system 110.

In addition, MAIP 128 can be equipped with an on-board security chip 149, which can be a hardware-based encryption chip. Chip 149 can encrypt output data of an instruction. This data can be resultant of a computation associated with the instruction. This prevents any rogue application from accessing on-chip data stored in the registers of MAIP 128. For example, if an application in AI applications 114 becomes compromised (e.g., by a virus), that compromised application may not access data generated by other applications in AI applications 114 from the registers of MAIP 128.

In the above example, the system hardware 116 may include a general purpose or a system processor and AI hardware 118 can include a set of GPUs or TPUs. The general purpose or system processor, GPUs and TPUs are all referred as computation circuitries. Also, the on-board security chip 149 is another example of computation circuitry. In this disclosure, the term “computation circuitry” refers to any hardware unit based on an electronic circuit that can perform an operation, such as a mathematical operation on some data or a control operation for controlling an action of a system.

FIG. 1B illustrates an exemplary system stack of a mission-critical system, in accordance with an embodiment of the present application. A system stack 150 of system 110 operates based on a TCU cluster 166 (e.g., in an MAIP). A scheduler 164 runs on cluster 166 that schedules the operations on TCU cluster 166. Scheduler 164 dictates the order at which the instructions are loaded on TCU cluster 166. A driver 162 allows different AI frameworks 156 to access functions of TCU cluster 166. AI frameworks 156 can include any library (e.g., a software library) that can facilitate AI-based computations, such as deep learning. Examples of AI frameworks 156 can include, but are not limited to, TensorFlow, Theano, MXNet, and DMLC.

AI frameworks 156 can be used to provide a number of AI services 154. Such services can include vision, speech, natural language processing, etc. One or more AI applications 152 can operate to facilitate AI services 154. For example, an AI application that determines a voice command from a user can use a natural language processing service based on TensorFlow. In addition to AI frameworks 156, driver 162 can allow commercial software 158 to access TCU cluster 166. For example, an operating system that operates system 110 can access TCU cluster 166 using driver 162.

### Fault Management

FIG. 1C illustrates an exemplary fault tolerance strategy of an MAIP supporting fault tolerance, in accordance with an embodiment of the present application. The fault tolerance feature of MAIP 128 allows system 110 (or a user of system 110) to execute real-time applications on MAIP 128 even in a failure scenario. MAIP 128 provides on-chip fault tolerance using a combination of hardware, time, and information redundancies 182, 184, and 186, respectively. To protect MAIP 128 from permanent faults 172 (e.g., one or more hardware elements of MAIP 128 become permanently faulty), significant hardware elements, which provide storage, computation, and control logic to MAIP 128, can have one or more spare elements. That hardware element can be used to provide hardware redundancy 182 in MAIP 128.

MAIP 128 can perform periodic self-tests to detect permanent faults 172. For example, MAIP 128 can be equipped with a spare register, which can be used by MAIP 128 to self-test the computations of other registers (e.g., one register at each cycle). If MAIP 128 detects a permanent fault of a register, the spare register can take over the operations of a faulty register in real time. In some embodiments, MAIP 128 can use an invariance check, such as a signature or hash-based check, for the self-test to reduce the amount of expected data stored.

MAIP 128 can also suffer transient faults 174, which may occur in MAIP 128 when an external or internal event causes the logical state of a hardware element (e.g., a transistor) of MAIP 128 to invert. Such a transient fault can occur for a finite length of time, usually does not recur (or repeat), and does not lead to a permanent failure. Transient faults 174 can be caused by an external source, such as voltage pulses in the circuitry caused by high-energy particles, and an internal source, such as coupling, leakage, power supply noise, and temporal circuit variations. To protect hardware elements in MAIP 128 from transient faults 174, MAIP 128 can be equipped with hardware, time, and/or information redundancies 182, 184, and 186, respectively.

MAIP 128 can incorporate information redundancy 186, such as ECC, to facilitate fault tolerance to storage operations. For example, MAIP 128 can provide information redundancy 186 to storage hardware elements, such as the registers, memory, pipeline, and bus in MAIP 128. In addition, MAIP 128 can also incorporate time redundancy 184 to facilitate fault tolerance to computational elements, such as an MXU and an accumulator, that perform calculations. MAIP 128 can use a multi-modular redundancy, such as a triple-modular redundancy (TMR), to facilitate redundancy to fault tolerance (FT) control logic. FT control logic can include reconfiguration logic, fail-over logic, and any other logic that supports fault tolerance in MAIP 128.

If the error or fault is uncorrectable based on time and/or information redundancies 184 and 186, MAIP 128 can provide roll back recovery to the corresponding fault. For data movement (e.g., in a data bus), rolling back usually includes re-transferring the data that includes the uncorrectable error. On the other hand, for computation, rolling back usually includes re-computing the entire layer associated with the data computation. If MAIP 128 includes a single point of failure, such as a hardware element that is not protected by time or information redundancy, MAIP 128 can incorporate element-level hardware redundancy 182. The data from the last correctly computed layer can be moved to the standby spare hardware element so that the spare element can start from where the failed element left off.

### Chip Architecture

FIG. 2A illustrates an exemplary chip architecture of a TCU in an MAIP supporting storage and replay, in accordance with an embodiment of the present application. A DPU 202 can include a control flow unit (CFU) 212 and a data flow unit (DFU) 214, which are coupled to each other via a network fabric (e.g., a crossbar) and may share a data buffer. CFU 212 can include a number of digital signal processing (DSP) units and a scheduler, a network fabric interconnecting them, and a memory. DFU 214 can include a number of tensor cores and a scheduler, a network fabric interconnecting them, and a memory. A number of DPUs 202, 204, 206, and 208, interconnected based on crossbar 210, form a DPU cluster 200.

A number of DPU clusters, interconnected based on a network fabric 240, can form a TCU 230. One such DPU cluster can be DPU cluster 200. TCU 230 can also include memory controllers 232 and 234, which can facilitate high-bandwidth memory, such as HBM2. TCU 230 can be designed based on a wafer level system integration (WLSI) platform, such as CoWoS (Chip On Wafer On Substrate). In addition, TCU 230 can include a number of input/output (I/O) interfaces 236. An I/O interface of TCU 230 can be a serializer/deserializer (SerDes) interface that may convert data between serial data and parallel interfaces.

FIG. 2B illustrates an exemplary chip architecture of a TCU cluster in an MAIP supporting storage and replay, in accordance with an embodiment of the present application. Here, a tensor processing unit (TPU) 250 is formed based on a cluster of TCUs. One such TCU can be TCU 230. In TPU 250, the TCUs can be coupled to each other using respective peripheral component interconnect express (PCIe) interfaces or SerDes interfaces. This allows individual TCUs to communicate with each other to facilitate efficient computation of tensor-based data.

### Fault Tolerance in an MAIP

FIG. 3 illustrates an exemplary architecture of an MAIP supporting fault tolerance, in accordance with an embodiment of the present application. In this example, system hardware 116 of system 110 includes a system processor 302 (i.e., the central processor of system 110), a memory device 304 (i.e., the main memory of system 110), and a storage device 306. Here, memory device 304 and storage device 306 can be off-chip. MAIP 128 can include a systolic array of parallel processing engines. In some embodiments, the processing engines form an MXU 322. MXU 322 can include a number of processing elements (PEs) 342, 344, 346, and 348. MXU 322 may further include an activation feeder and a weight buffer (WB) 340 with a number of memory devices (or buffers), each for a corresponding PE. Each of PEs 342, 344, 346, and 348 is capable of processing tensor-based computations and can include one or more accumulation buffers, which can be one or more registers that can store the data generated by the computations executed by the corresponding PE.

MAIP 128 can also include a scalar computing unit (SCU) 326. SCU 326 can include a number of scalar elements (SEs) 362, 364, 366, and 368. Each of SEs 362, 364, 366, and 368 is capable of processing scalar computations. MAIP 128 can also include a dedicated unit (or units), a command sequencer (CSQ) 312, to execute instructions in an on-chip instruction buffer 330 that control the systolic array (i.e., MXU 322) for computations. A finite state machine (FSM) 314 of CSQ 312 dispatches a respective instruction in instruction buffer 330. In addition, upon detecting a control instruction (e.g., an instruction to switch to a low-power mode), FSM 314 may dispatch an instruction to SCU 326.

Data generated by intermediate computations from MXU 322 are stored in an on-chip unified buffer (UB) 316. UB 316 can store data related to an AI model, such as feature data, activation data (for current layer, next layer, and several or all previous layers), training target data, weight gradients, and node weights. Data from UB 316 can be input to subsequent computations. Accordingly, MXU 322 can retrieve data from UB 316 for the subsequent computations. MAIP 128 can also include a direct memory access (DMA) controller 320, which can transfer data between memory device 304 and UB 316.

MAIP 128 can use a communication interface 318 to communicate with components of system 110 that are external to MAIP 128. Examples of interface 318 can include, but are not limited to, a PCIe interface and a network interface card (NIC). MAIP 128 may obtain instructions and input data, and provide output data and/or the recorded contexts using interface 318. For example, the instructions for AI-related computations are sent from system software 310 (e.g., an operating system) of system 110 to instruction buffer 330 via interface 318. Similarly, DMA controller 320 can send data in UB 316 to memory device 304 via interface 318.

During operation, software 310 provides instruction blocks 332 and 334 corresponding to the computations associated with an AI operation. For example, software 310 can provide an instruction block 332 comprising one or more instructions to be executed on MAIP 128 via interface 318. Instruction block 332 can correspond to one computational stage of an AI model (e.g., a neural network). Similarly, software 310 can provide another instruction block 334 corresponding to a subsequent computational stage of the AI model. Instruction blocks 332 and 334 are then stored in instruction buffer 330. MXU feeder 352 and SCU feeder 354 can issue the instructions from instruction buffer 330 to MXU 322 and SCU 326, respectively.

Upon completion of execution of an instruction block in instruction buffer 330, data generated from the execution is stored in UB 316. Based on a store instruction, DMA controller 320 can transfer the data from UB 316 to memory device 304. For more persistent storage, data can be transferred from memory device 304 to storage device 306. DMA controller 320 can also store data directly through common communication channels (e.g., using remote DMA (RDMA)) via a network 380 to non-local storage on a remote storage server 390. In some embodiments, storage server 390 can be equipped with a software simulator or another MAIP that can replay the stored data.

MAIP 128 can also include a set of registers 350. It should be noted that even though registers 350 are shown as a separate block in FIG. 3, the registers in registers 350 can be distributed across multiple hardware elements, such as MXU 322 and SCU 326. MAIP 128 can also include a data mover (DMV) 360, which can control data transfer between on-chip memories and off-chip memories via a DMV ring 366 (e.g., a ring bus). DMV 360 can include a central node 362 and one or more ring nodes, such as ring node 364.

Registers 350 can include one or more spare registers, which can take over if a regular register in registers 350 suffers a permanent fault. Processor 302 of system 110 can run tests on MAIP 128 to determine whether registers 350 are producing correct results to determine any permanent fault. In some embodiments, registers 350 also use TMR to determine any permanent or transient fault. A respective register in registers 350 can incorporate information redundancy (e.g., using ECC). For example, if a register includes 32 bits, 26 bits can be available for register fields and 6 bits for ECC. If the register addresses are to be protected as well, the register can use 25 bits for register fields and 7 bits for ECC.

MAIP 128 can include a spare DMA controller that can be used to test DMA controller 320 for permanent faults. This testing can be based on a self-test that checks invariance (e.g., a signature or hash-based check) of a sequence of transfers performed by DMA controller 320. This test can be performed per epoch. An epoch indicates that the input dataset has passed forward and backward through an AI model (e.g., a neural network) just once. In the example in FIG. 1A, an epoch can indicate that input data 102 has once passed forward and backward through AI model 113 in MAIP 128. If DMA controller 320 includes multiple DMA controllers, each DMA controller can take turns to be checked against the spare DMA controller in a cyclic way. If a permanent fault is detected for DMA controller 320, the spare DMA controller can replace DMA controller 320.

On the other hand, DMA controller 320 can use information redundancy to address transient faults. For example, data transferred from memory 304 can include ECC, which can be used to correct some errors (e.g., single bit errors). If the error detected by the ECC is uncorrectable, DMA controller 320 can roll back and re-transfer the data that includes the error from memory 304. In some embodiments, DMA controller 320 can issue an interrupt request to system 110 to initiate the re-transfer.

To address any hardware failure of communication interface 318, MAIP 128 can incorporate hardware redundancy. For example, MAIP 128 can perform a self-test (i.e., when MAIP 128 powers on) to determine whether communication interface 318 is operational. If communication interface 318 suffers a hardware failure, MAIP 128 can switch to a spare interface.

MAIP 128 can include another DMV ring to protect DMV ring 366 from hardware failures. These two rings can be two opposite rings. The data carried by DMV ring 366 can incorporate information redundancy, such as ECC, to address transient faults. If an error detected by the ECC is uncorrectable, DMV ring 366 can roll back and re-transfer the data that includes the error. In addition, to address any permanent fault, MAIP 128 includes a spare DMV central unit and a spare DMV agent. MAIP 128 can self-test using the spare DMV central unit per epoch, which can include an invariance check of a sequence of transfers by DMV 360. Similarly, MAIP 128 can self-test using a spare DMV agent per epoch, which can include an invariance check of a sequence of transfers by DMV 360. Upon detecting a permanent fault of the DMV central unit or the DMV agent, MAIP 128 can replace the faulty DMV central unit or DMV agent with the corresponding spare element.

On the other hand, DMV 360 can use information redundancy to address transient faults. For example, data transferred from CSQ 312 can include ECC, which can be used to correct some errors (e.g., single bit errors). The transient fault associated with DMV 360 can be triggered by the DMV central unit and/or the DMV agent. For both cases, if an error detected by the ECC is uncorrectable, DMV 360 can roll back and re-transfer the data that includes the error from CSQ 312.

Similar to DMV 360, to address any permanent fault, MAIP 128 includes a spare UB. MAIP 128 can self-test UB 316 using the spare UB per epoch. The self-test can include a standard memory test (e.g., a March-based test algorithm and a diagonal test algorithm) to determine whether UB 316 is currently operating correctly. Upon detecting a permanent fault of UB 316, MAIP 128 can replace faulty UB 316 with the spare UB. Furthermore, UB 316 can use information redundancy to address transient faults. For example, data transferred from MXU 322 and SCU 326 can include ECC, which can be used to correct some errors.

If an error detected by the ECC is uncorrectable, UB 316 can roll back the faulty data that includes the error. If the error is related to data transfer, DMA controller 320 and/or DMV 360 can re-transfer the faulty data to UB 316. On the other hand, if the error is related to computation, MXU 322 and/or SCU 326 can re-compute the entire layer (e.g., a layer of a neural network) that includes the error. MAIP 128 can determine whether an error is related to data transfer or computation by checking the ECC for the same block of data for DMA controller 320, DMV 360, MXU 322 and/or SCU 326. If the ECC indicates an error for DMA controller 320 and/or DMV 360, MAIP 128 can determine that the error is related to data transfer. Otherwise, MAIP 128 can determine that the error is related to computation.

Typically, TPUs are modular and need a separate TPU to facilitate redundancy. However, since MXU 322 includes multiple PEs, they can be used for efficient processing as well as fault tolerance. For example, instead of an entire spare MXU, MXU 322 can include one or more spare PEs and at least one spare WB to address any permanent fault. Here, one or two spare PEs can address permanent faults of up to one or two operational PEs, respectively. MXU 322 can self-test one of PEs 342, 344, 346, and 348 using the spare PE per epoch. PEs 342, 344, 346, and 348 can take turns to be checked against the spare PE in a cyclic way. The self-test can include an invariance check of a sequence of known partial sums (e.g., MXU 322 can use each of its PEs to compute the partial sum and check whether the calculated sum is correct). Similarly, MXU 322 can also self-test WB 340 using the spare PE per epoch using a standard memory test. Upon detecting a permanent fault of a PE or WB 340, MXU 322 can replace the faulty PE with a spare PE or the faulty WB 340 with the spare WB, respectively.

MXU 322 can use time redundancy and/or hardware redundancy to address transient faults. To implement time redundancy, MXU 322 can compute each partial sum multiple times to determine whether the computed partial sum is correct. To implement hardware redundancy, MXU 322 can use multiple PEs to compute a partial sum, and based on their match, MXU 322 determines whether the computed partial sum is correct. Furthermore, MXU 322 can use information redundancy, such as ECC, to address transient faults of WB 340. If an error detected by the ECC is uncorrectable, MXU 322 can roll back the faulty data that includes the error. If the error is related to data transfer, DMA controller 320 and/or DMV 360 can re-transfer the faulty data to WB 340. On the other hand, if the error is related to computation, MXU 322 can re-compute the entire layer (e.g., a layer of a neural network) that includes the error.

SCU 326 can include a spare SE and self-test one of SEs 362, 364, 366, and 368 using the spare SE per epoch. SEs 362, 364, 366, and 368 can take turns to be checked against the spare SE in a cyclic way. The self-test can include an invariance check of a sequence of known partial sums (e.g., SCU 326 can use each of its SEs to compute the partial sum and check whether the calculated sum is correct). SCU 326 can use time redundancy and/or hardware redundancy to address transient faults. To implement time redundancy, SCU 326 can compute each partial sum multiple times to determine whether the computed partial sum is correct. To implement hardware redundancy, SCU 326 can use multiple SEs to compute a partial sum, and based on their match, SCU 326 determines whether the computed partial sum is correct. If incorrect, SCU 326 can re-compute the entire layer that includes the error.

MAIP 128 can include a spare on-chip memory bank (e.g., DDR/HBM in MXU 322 and/or SCU 326) to address a permanent fault of on-chip memory. MAIP 128 can self-test the on-chip memory using the spare memory bank per epoch using a standard memory test. Upon detecting a permanent fault of the on-chip memory, MAIP 128 can replace the faulty memory with the spare memory. Furthermore, MAIP 128 can use information redundancy, such as ECC, to address transient faults of the on-chip memory. If an error detected by the ECC is uncorrectable, MXU 322 can roll back the faulty data that includes the error. To do so, DMA controller 320 and/or DMV 360 can re-transfer the faulty data to the on-chip memory.

MAIP 128 can include a spare CSQ to address permanent faults of CSQ 312, which can self-test using the spare CSQ per epoch. The self-test can include an invariance check of a sequence of known commands (e.g., how those commands are delegated by CSQ 312). Furthermore, CSQ 312 can use information redundancy, such as ECC, to address transient faults. For example, data transferred from host to CSQ 312 and data transferred from CSQ 312 to MXU 322 and SCU 326 can incorporate ECC. The interface between CSQ 312 and MXU 322/SCU 326 can facilitate ECC protection. If an error detected by the ECC is uncorrectable, CSQ 312 can roll back the faulty data that includes the error. To do so, CSQ 312 can re-obtain the instruction block for the entire layer (e.g., instruction block 332) and re-execute the corresponding instructions on MXU 322/SCU 326 to re-compute the entire layer.

MAIP 128 can include a spare MXU feeder and a spare SCU feeder to address permanent faults of MXU feeder 352 and SCU feeder 354. MXU feeder 352 and SCU feeder 354 can self-test using the spare MXU feeder and the spare SCU feeder per epoch, respectively. The self-test can include an invariance check of a sequence of known weights and activation data. Furthermore, MXU feeder 352 and SCU feeder 354 can use information redundancy, such as ECC, to address transient faults. For example, MXU feeder 352 can incorporate ECC into each weight and activation data, and its entire feeder pipeline. Similarly, SCU feeder 354 can incorporate ECC into each full sum and activation data, and its entire feeder pipeline. If an error detected by the ECC is uncorrectable, MXU feeder 352 and/or SCU feeder 354 can roll back the faulty data that includes the error. To do so, MXU feeder 352 and/or SCU feeder 354 can re-send the corresponding instruction block for the entire layer and re-execute the corresponding instructions in MXU 322/SCU 326 to re-compute the entire layer.

In addition, MAIP 128 can use TMR to facilitate fault tolerance to MXU re-mapper, SCU re-mapper, fail-over logic (e.g., the logic that triggers any fail-over action), error detection logic (e.g., ECC generator and checker, invariance generator and checker), and interrupt logic for rolling back and component level redundancy. MAIP 128 can use the majority result (the one produced by at least two elements) to provide fault tolerance to the corresponding hardware element.

### Exemplary Redundancies

FIG. 4A illustrates exemplary information redundancy and hardware redundancy for facilitating fault tolerance in an MAIP, in accordance with an embodiment of the present application. This example uses registers 350 of MAIP 128 to illustrate information redundancy and hardware redundancy. Registers 350 can be in a single hardware element or in multiple hardware elements in MAIP 128. Registers 350 can include a number of registers 410, 412, 414, 416, and 418. Registers 410, 412, and 414 can be data registers that hold intermediate computational data (e.g., in MXU 322 in FIG. 3). Registers 416 and 418 can be control registers that can hold instructions.

One or more of registers 350 can be user-configurable. A user-configurable register can be configured by system 110 (e.g., system software 310) that can indicate the mode of operation for MAIP 128. The mode of operation can indicate how some of the operations are performed by MAIP 128. Regardless of the type and/or location of a register in MAIP 128, each register, such as register 418, can be protected against permanent and transient faults using hardware and information redundancies, respectively.

To facilitate fault tolerance in the event of a permanent fault, registers 350 can include a spare register 420. Host processor 302 of system 110 can run tests 402 (e.g., path sensitization and scan testing) on registers 350 to determine whether a register in registers 350 is permanently faulty (e.g., stuck-at-fault). Tests 402 can include one or more tests that detect any detectable faults in a class of permanent faults. Tests 402 can determine whether register 418 is producing correct results to determine any permanent fault. If a permanent fault is detected for a control register, such as register 418, spare register 420 can take over the operations of that control register 418 (e.g., start operating as a control register). On the other hand, if a permanent fault is detected for a data register, such as register 414, spare register 420 can take over the operations of that data register 414 (e.g., start operating as a data register).

In some embodiments, registers 350 also use TMR to determine any permanent or transient fault. A respective register in registers 350 can incorporate information redundancy (e.g., using ECC). For example, register 416 can include ECC bits 422 and data bits 424. Data bits 424 can store data associated with the corresponding hardware element. For example, if register 416 is a pipeline register, data bits 424 can store data in the pipeline. ECC bits 422 can include ECC corresponding to data stored in data bits 424. ECC bits 422 can detect errors. If the error is a single-bit error, ECC bits 422 can correct that error in data bits 424.

Similarly, register 418 can include ECC bits 432 and control bits 434. If register 418 is user-configurable, register 418 can also include one or more configuration bits 436. The bit pattern of configuration bits 436 may indicate how MAIP 128 performs certain operations (e.g., precision level). ECC bits 432 can include ECC corresponding to a control instruction stored in control bits 434 and/or the bit pattern of configuration bits 436. If register 416 or 418 includes 32 bits, 26 bits can be available for register fields (data bits 424, or control bits 434 and/or configuration bits 436, respectively) and 6 bits for ECC. If the register addresses are to be protected as well, register 416 or 418 can use 25 bits for register fields and 7 bits for ECC.

FIG. 4B illustrates exemplary self-testing and time redundancy for facilitating fault tolerance in an MAIP, in accordance with an embodiment of the present application. MXU 322 can include at least one spare PE 450 and at least one spare WB 452 to address any permanent fault. MXU 322 can self-test one of PEs 342, 344, 346, and 348 using PE 450 per epoch. PEs 342, 344, 346, and 348 can take turns to be checked against PE 450 in a cyclic way. For example, MXU 322 can use PE 342 and PE 450 to compute the same partial sum and check whether the calculated results from PEs 342 and 450 match. Similarly, MXU 322 can also self-test WB 340 using PE 450 per epoch using a standard memory test to determine whether the storage operation of WB 340 is executing correctly. Upon detecting a permanent fault of PE 342 or WB 340, MXU 322 can replace faulty PE 342 with PE 450 or faulty WB 340 with WB 452, respectively.

MXU 322 can use time redundancy and/or hardware redundancy to address transient faults. To implement time redundancy, MXU 322 can compute each partial sum twice using the same PE 342, and if the calculated results don't match, MXU 322 can trigger a roll back. MXU 322 may also compute each partial sum thrice using the same PE 342, and if the calculated results don't match, MXU 322 can use the majority result (the one calculated at least twice). If there is no majority result, MXU 322 can trigger a roll back.

To implement hardware redundancy 462, MXU 322 can use two PEs, such as PEs 342 and 344, to compute each partial sum, and if the calculated results don't match, MXU 322 can trigger a roll back. MXU 322 can also use TMR 464, by using three PEs, such as PEs 342, 344, and 346, to compute each partial sum, and if the calculated results don't match, MXU 322 can use the majority result (the one calculated by two PEs). If there is no majority, MXU 322 can trigger a roll back. Rolling back can include MXU 322 re-computing the entire layer (e.g., a layer of a neural network) that includes the error.

Furthermore, MXU 322 can use information redundancy, such as ECC 442, to address transient faults of WB 340. A set of bits in WB 340 can be dedicated for ECC 442. If an error detected by ECC 442 is uncorrectable, MXU 322 can roll back the faulty data that includes the error. If the error is related to data transfer, the faulty data can be re-transferred to WB 340. On the other hand, if the error is related to computation, MXU 322 can re-compute the entire layer using its PEs (e.g., a layer of a neural network) that include the error. MXU 322 can determine whether the error is related to computation by detecting an error in the computations in its PEs while also detecting an error in corresponding data in WB 340.

### Operations

FIG. 5A presents a flowchart 500 illustrating a method of an MAIP testing for and recovering from a permanent failure, in accordance with an embodiment of the present application. During operation, the MAIP selects a hardware element (referred as a first computation circuitry) and a corresponding spare hardware element (referred as a spare computation circuitry) in step 502. In one example, the hardware element may correspond to a set of SCUs and the spare hardware correspond to another set of SCUs. In another example, the hardware element may correspond to a set of DPUs and the spare hardware correspond to another set of DPUs. The hardware element may also correspond to other processing blocks of the MAIP. The MAIP then performs the same computations according to a set of instructions using both hardware elements and compares the computations to determine a failure (operation 504). The set of instructions may be stored in instruction buffer. The computations associated with the set of instructions comprise target operations associated with one or more layers of the neural networks or associated with the AI model. For example, the target operations may correspond to the computations of weighted partial sum for one or more given nodes of the neural networks. In this case, the hardware element may comprise the MXU (matrix multiplier unit). In another example, the target operations may correspond to the computations to derive the activation function for a given weighted sum. In this case, the hardware element may comprise the SCU (scalar computing unit). The MAIP checks whether a fault has been detected (operation 506). For example, a fault may be declared if the test results from the hardware element and the corresponding spare hardware element do not match. If a fault has been detected (i.e., the “YES” path from step 506), the MAIP swaps operations of the faulty hardware element with the spare hardware element (operation 508). Otherwise (i.e., the “NO” path from step 506), the MAIP continues to select a next hardware element and a corresponding spare hardware element (operation 502). It should be noted that the operations described in conjunction with FIG. 5A can be executed for each type of hardware element in parallel. For example, the MAIP can check its registers and PEs in parallel using respective spare hardware elements. The MAIP may include a processor, controller, logic circuits (e.g. a finite state machine, FSM) or a combination of them to facilitate the above mentioned tasks such as performing test results based on the same computations using both hardware elements, comparing the test results and determining a fault in response to a mismatch between the first test result and the second test result. The processor, controller or logic circuits configured to perform the above operations can be referred as control circuitry in this disclosure and the control circuitry may not be explicitly shown in the MAIP drawings as illustrated in FIG. 1 through FIG. 4. The MAIP may include a processor, controller, logic circuits (e.g. a finite state machine, FSM) or a combination of them to facilitate swapping operations of the first computation circuitry with the spare computation circuitry when the fault is determined. The processor, controller or logic circuits configured to perform the swapping operations can be referred as recovery circuitry in this disclosure and the recovery circuitry may not be explicitly shown in the MAIP drawings as illustrated in FIG. 1 through FIG. 4.

FIG. 5B presents a flowchart 530 illustrating a method of an MAIP facilitating fault recovery using information redundancy, in accordance with an embodiment of the present application. During operation, the MAIP detects an error based on information redundancy (operation 532) and checks whether the error is recoverable (operation 534). If the error is recoverable, the MAIP recovers the error based on the redundant information (e.g., ECC bits) (operation 536). If the error is not recoverable, the MAIP checks whether the error is in data transfer (operation 538).

If the error is in data transfer (e.g., data transferred from the host or between hardware elements in the MAIP), the MAIP rolls back to the previous correct computation layer (e.g., a neural network layer that has been computed by the MAIP without a fault or an error) by re-transferring data of that computation layer (operation 540). If the error is not in data transfer (i.e., in computations, such as computations in the MXU of the MAIP), the MAIP rolls back to the previous correct computation layer by re-computing data of that computation layer (operation 542).

FIG. 5C presents a flowchart 550 illustrating a method of an MAIP facilitating fault recovery using hardware redundancy, in accordance with an embodiment of the present application. During operation, the MAIP obtains results from multiple hardware elements (operation 552) and determines whether the results match (operation 554). If the results match, the MAIP determines a faultless computation (operation 556). If the results don't match, the MAIP can check for a majority result (operation 558). It should be noted that a majority result can be obtained if at least three hardware elements are used (e.g., using TMR).

If a majority result is obtained (e.g., the majority of hardware elements has produced the same result), the MAIP can set the majority result as the output and associate a fault with the hardware element generating the incorrect result (operation 560). If that hardware element generates an incorrect result for more than a threshold number of times, the MAIP may consider that hardware element to be permanently faulty. In this way, the MAIP can use TMR to determine permanent fault as well. If a majority result cannot be obtained, the MAIP rolls back to the previous correct computation layer by re-computing data of that computation layer (operation 562). If these hardware elements continue to generate unmatched non-majority results for more than a threshold number of times, the MAIP may consider that the hardware elements are permanently faulty.

FIG. 5D presents a flowchart 570 illustrating a method of an MAIP facilitating fault recovery using time redundancy, in accordance with an embodiment of the present application. During operation, the MAIP computes results multiple times using a hardware element (operation 572) and determines whether the results match (operation 574). If the results match, the MAIP determines a faultless computation (operation 576). If the results don't match, the MAIP can check for a majority result (operation 578).

It should be noted that a majority result can be obtained if the MAIP computes at least three results using the hardware element. If a majority result is obtained (e.g., the majority of times the hardware element has produced the same result), the MAIP can set the majority result as the output (operation 580). If a majority result cannot be obtained, the MAIP rolls back to the previous correct computation layer by re-computing data of that computation layer (operation 582). Under such a scenario, the MAIP may consider that the hardware element is permanently faulty.

FIG. 6 presents a flowchart 600 illustrating a method of an MAIP rolling back to a correct computation layer, in accordance with an embodiment of the present application. During operation, the MAIP can determine a permanent fault associated with a hardware element (operation 602) and identify a corresponding spare hardware element (operation 604). The MAIP then obtains the calculated data from the last correctly computed layer (operation 606) and transfers the obtained data to the spare hardware element (operation 608). The MAIP initiates operations/computations on the spare hardware element based on the transferred data (operation 610).

### Exemplary Computer System and Apparatus

FIG. 7 illustrates an exemplary computer system supporting a mission-critical system, in accordance with an embodiment of the present application. Computer system 700 includes a processor 702, a memory device 704, and a storage device 708. Memory device 704 can include a volatile memory device (e.g., a dual in-line memory module (DIMM)). Furthermore, computer system 700 can be coupled to a display device 710, a keyboard 712, and a pointing device 714. Storage device 708 can store an operating system 716, a mission-critical system 718, and data 736. In some embodiments, computer system 700 can also include AI hardware 706 comprising one or more MAIPs, as described in conjunction with FIG. 1A. Mission-critical system 718 can facilitate the operations of one or more of: mission-critical system 110 and the MAIPs within system 110.

Mission-critical system 718 can include instructions, which when executed by computer system 700 can cause computer system 700 to perform methods and/or processes described in this disclosure. Specifically, mission-critical system 718 can also include instructions for the mission-critical system operating AI hardware 706 to address a minimum computing requirement in the event of a power failure (power module 720). Furthermore, mission-critical system 718 includes instructions for the mission-critical system virtualizing the resources of AI hardware 706 (virtualization module 722). Moreover, mission-critical system 718 includes instructions for the mission-critical system encrypting data generated by AI hardware 706 (encryption module 724).

Mission-critical system 718 can also include instructions for facilitating hardware redundancy (hardware redundancy module 726), information redundancy (information redundancy module 728), and time redundancy (time redundancy module 730). Mission-critical system 718 can also include instructions for recovering from a permanent and/or transient fault determined based on hardware, time, and information redundancies (recovery module 732). Mission-critical system 718 may further include instructions for the mission-critical system sending and receiving messages (communication module 734). Data 736 can include any data that can facilitate the operations of mission-critical system 110.

FIG. 8 illustrates an exemplary apparatus that supports a mission-critical system, in accordance with an embodiment of the present application. Mission-critical apparatus 800 can comprise a plurality of units or apparatuses which may communicate with one another via a wired, wireless, quantum light, or electrical communication channel. Apparatus 800 may be realized using one or more integrated circuits, and may include fewer or more units or apparatuses than those shown in FIG. 8. Further, apparatus 800 may be integrated in a computer system, or realized as a separate device that is capable of communicating with other computer systems and/or devices. Specifically, apparatus 800 can comprise units 802-816, which perform functions or operations similar to modules 720-734 of computer system 700 of FIG. 7, including: a power unit 802; a virtualization unit 804; an encryption unit 806; a hardware redundancy unit 808, an information redundancy unit 810, a time redundancy unit 812, a recovery unit 814; and a communication unit 816.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing embodiments described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. A mission-critical AI (Artificial Intelligence) processor, comprising:
multiple types of HEs (hardware elements) comprising one or more first-type HEs configured to perform operations associated with multi-layer NN (neural network) processing;
at least one spare first-type HE (hardware element);
a data buffer to store correctly computed data in a previous layer of multi-layer NN processing computed using said one or more first-type HEs; and
fault tolerance (FT) control logic configured to:
determine a fault in a current layer NN processing associated with said one or more first-type HEs;
cause the correctly computed data in the previous layer of multi-layer NN processing to be copied or moved to said at least one spare first-type HE; and
cause said at least one spare first-type HE to perform the current layer NN processing using said at least one spare first-type HE and the correctly computed data in the previous layer of multi-layer NN processing.

2. The mission-critical AI processor of claim 1, wherein said one or more first-type HEs comprises one or more matrix multiplier units (MXUs), weight buffers (WBs) or processing elements (PEs).

3. The mission-critical AI processor of claim 1, wherein said one or more first-type HEs comprises one or more scalar computing units (SCUs) or scalar elements (SEs).

4. The mission-critical AI processor of claim 1, wherein said one or more first-type HEs comprises one or more registers, DMA (direct memory access) controllers, on-chip memory banks, command sequencers (CSQs) or a combination thereof.

5. The mission-critical AI processor of claim 1, wherein, when said one or more first-type HEs corresponds to a storage, information redundancy is used to detect storage error and the fault corresponds to an un-correctable storage error.

6. The mission-critical AI processor of claim 5, wherein the information redundancy corresponds to error-correction coding (ECC).

7. The mission-critical AI processor of claim 1, wherein at least three first-type HEs (hardware elements) are used to execute same operations and the fault corresponds to a condition that no majority result can be determined among said at least three first-type HEs.

8. A method for mission-critical AI (Artificial Intelligence) processing, comprising:
storing correctly computed data, calculated using a mission-critical AI processor, in a previous layer of multi-layer NN (Neural Network) processing;
performing mission-critical operations with at least one type of redundancy for a current layer of multi-layer NN processing using the mission-critical AI processor;
determining whether a fault occurs based on results of the mission-critical operations for the current layer of multi-layer NN processing; and
in response to the fault, re-performing the mission-critical operations for the current layer of multi-layer NN processing using the mission-critical AI processor and the correctly computed data in the previous layer of multi-layer NN processing.

9. The method of claim 8, wherein said at least one type of redundancy comprises hardware redundancy, information redundancy, time redundancy or a combination thereof.

10. The method of claim 9, wherein said at least one type of redundancy comprises the hardware redundancy; the mission-critical AI processor comprises multiple hardware elements (HEs) for at least one type of hardware element (HE); and wherein two or more HEs for said at least one type of HE are used to perform same mission-critical operations for the current layer of multi-layer NN processing.

11. The method of claim 10, wherein if results of the same mission-critical operations for the current layer of multi-layer NN processing do not match, but a majority result of the same mission-critical operations for the current layer of multi-layer NN processing exists, no fault is declared and the majority result of the same mission-critical operations for the current layer of multi-layer NN processing is used as the correctly computed data for the current layer of multi-layer NN processing.

12. The method of claim 10, wherein if results of the same mission-critical operations for the current layer of multi-layer NN processing do not match and no majority result of the same mission-critical operations for the current layer of multi-layer NN processing exists, the fault is determined.

13. The method of claim 9, wherein said at least one type of redundancy comprises the information redundancy and the mission-critical AI processor uses at least one type of data with redundant information to detect data error in said at least one type of data, and wherein said at least one type of data is associated with the mission-critical operations for the current layer of multi-layer NN processing.

14. The method of claim 13, wherein when the data error in said at least one type of data is un-recoverable and the data error is due to data transfer, said at least one type of data is re-transferred.

15. The method of claim 13, wherein when the data error in said at least one type of data is un-recoverable and the data error is not due to data transfer, the fault is determined.

16. The method of claim 13, wherein the mission-critical AI processor uses error-correcting-coding (ECC) to provide the redundant information for said at least one type of data.

17. The method of claim 13, wherein said at least one type of data is associated with data storage using registers, on-chip memory, weight buffer (WB), unified buffer (UB) or a combination thereof.

18. The method of claim 9, wherein said at least one type of redundancy comprises the time redundancy and the mission-critical AI processor performs same mission-critical operations at least twice for the current layer of multi-layer NN processing.

19. The method of claim 18, wherein if results of the same mission-critical operations for the current layer of multi-layer NN processing do not match, but a majority result of the same mission-critical operations for the current layer of multi-layer NN processing exists, no fault is declared and the majority result of the same mission-critical operations for the current layer of multi-layer NN processing is used as the correctly computed data for the current layer of multi-layer NN processing.

20. The method of claim 18, wherein if results of the same mission-critical operations for the current layer of multi-layer NN processing do not match and no majority result of the same mission-critical operations for the current layer of multi-layer NN processing exists, the fault is determined.

21. A mission-critical AI (Artificial Intelligence) system, comprising:
a system processor;
a system memory device;
a communication interface; and
a mission-critical AI (Artificial Intelligence) processor coupled to the communication interface; and
wherein the mission-critical AI processor comprises:
multiple types of HEs (hardware elements) comprising one or more first-type HEs configured to perform operations associated with multi-layer NN (neural network) processing;
at least one spare first-type HE;
a data buffer to store correctly computed data in a previous layer of multi-layer NN processing computed using said one or more first-type HEs; and
fault tolerance (FT) control logic configured to:
determine a fault in a current layer NN processing associated with said one or more first-type HEs;
cause the correctly computed data in the previous layer of multi-layer NN processing to be copied or moved to said at least one spare first-type HE; and
cause said at least one spare first-type HE to perform the current layer NN processing using said at least one spare first-type HE and the correctly computed data in the previous layer of multi-layer NN processing.

22. The mission-critical AI system of claim 21, wherein the communication interface is one of:
a peripheral component interconnect express (PCIe) interface; and
a network interface card (NIC).
